(19) United States
(12) Patent Application Publication
(10) Pub. No.: US 2009/0200166 A1
(43) Pub. Date: Aug. 13, 2009

(54) Method of Analyzing Hemoglobin by Capillary Eletrophoresis

(75) Inventors: Yusuke Nakayama, Kyoto (JP); Koji Sugiyama, Kyoto (JP)

Correspondence Address: MORGAN LEWIS & BOCKIUS LLP, 1111 PENNSYLVANIA AVENUE NW, WASHINGTON, DC, 20004, US

(73) Assignee: ARKRAY, Inc., Kyoto (JP)

(21) Appl. No.: 12/367,260

(22) Filed: Feb. 6, 2009

(30) Foreign Application Priority Data
Feb. 8, 2008 (JP) JP 2008-029751

(51) Int. Cl. G01N 27/447

(52) U.S. Cl. 204/451

(57) ABSTRACT

The present invention is directed to methods of analyzing hemoglobin by capillary electrophoresis involving electrophoresing a hemoglobin-containing sample in the presence of chaotropic anion.

### CROSS-REFERENCE TO RELATED APPLICATIONS

This application claims the benefit of Japanese Patent Application No. 2008-029751 filed on Feb. 8, 2008, incorporated herein by reference in its entirety.

### BACKGROUND OF THE INVENTION

The present invention relates to a method of analyzing hemoglobin by a capillary electrophoresis method. Hemoglobin (Hb) reacts with glucose in the blood to become glycated Hb. There are different types of glycated Hb that occur in the bloodstream. One type of glycated hemoglobin, hemoglobin A1c (HbA1c), is used as an important indicator in the diagnosis and treatment of diabetes. HbA1c has a chemical structure in which an N-terminal valine of the β chain of hemoglobin A (HbA0) is glycated. Stable and unstable forms of HbA1c exist in the bloodstream, and whether HbA1c is in a stable or unstable form depends on the stage of the glycation reaction. HbA0 becomes unstable HbA1c when a N-terminal valine of the β chain of HbA0 is reacted with glucose, and the glucose reacts with Hb to form an aldimine (e.g., Schiff base). Unstable HbA1c becomes stable HbA1c when the aldimine is changed to a ketoamine group by an Amadori rearrangement. The level of stable HbA1c in blood is an indicator of the glucose levels that have been present in a patient's blood for a few months prior to testing, and its measurement for the treatment and diagnosis of diabetes is endorsed by The Japan Diabetes Society.

Examples of methods that can be used to determine glycated hemoglobin levels in blood include immunoassays, enzymatic methods, affinity chromatography methods, HPLC (high pressure liquid chromatography or high performance liquid chromatography) methods, and capillary electrophoresis (CE) methods, among others. Because the immunoassay methods and the enzymatic methods can be performed using an autoanalyzer, they have the advantage of being able to readily handle a large quantity of specimens. However, the immunoassay methods and the enzymatic methods lack sufficient measurement accuracy to be relied on by diabetes patients as a blood glucose control indicator (preventive marker for onset of complications). Further, in principle, affinity chromatography methods have only low specificity for the glycated valine of the β chain N-terminal in HbA1c, and thus, glycated lysine residues in Hb molecules can interfere with the making of accurate measurements. Therefore, the measurement accuracy of HbA1c by affinity chromatography methods is low. HPLC methods are widely used to determine glycated hemoglobin levels for diabetes patients (see, for example, JP 3429709 B). However, HPLC methods require specialized instruments that are large and expensive. In order for HPLC methods to be practical for the analysis of groups of samples (as in a clinical laboratory), the hemoglobin analyzer would have to be downsized. It would be difficult to reduce the size and cost of such instruments. In contrast, capillary electrophoresis instruments require less space. In capillary electrophoresis methods, an electroosmotic flow is generated by movement of an ion due to application of voltage. The ion is gathered at an inner wall of the capillary channel during electrophoresis. With respect to the capillary electrophoresis method, CE instruments can be downsized by reducing the length of the capillary channel and by microchipping a part of a capillary electrophoresis apparatus.

### SUMMARY OF THE INVENTION

Certain aspects of the present invention are directed to methods of analyzing hemoglobin by capillary electrophoresis. A sample comprising hemoglobin is introduced into a electrophoresis buffer solution in a capillary channel, and then voltage is applied to the ends of the capillary channel. The sample is electrophoresed in a buffer solution comprising a chaotropic anion.

Some aspects of the present invention are directed to methods that permit the separation and detection of stable HbA1c, unstable HbA1c, and modified Hb within a sample. Therefore, levels of stable HbA1c may be analyzed with a high degree of accuracy and quickly as compared to conventional methods.

Certain aspects of the present invention are directed to methods that permit the detection and quantitation of stable HbA1c, unstable HbA1c, modified Hb, and other forms of hemoglobin found in a sample. Further, with respect to the analysis method of some aspects of the present invention, stable HbA1c may be measured with high accuracy and in a short time using capillary electrophoresis, and the CE instrumentation may require less space than the instrumentation used in conventional methods for measuring hemoglobin. Certain aspects of the present invention are directed to microchip electrophoresis methods for determining hemoglobin levels, which may also require less space than the instrumentation used in conventional methods (i.e., HPLC separation of different hemoglobin types).

### BRIEF DESCRIPTION OF THE DRAWINGS

FIG. 1 is a graph showing the analysis result of hemoglobin in Example 1-1 of the present invention.

FIG. 2 is a graph showing the analysis result of hemoglobin in Example 1-2 of the present invention.

FIG. 3 is a graph showing the analysis result of hemoglobin in Example 1-3 of the present invention.

FIG. 4 is a graph showing the analysis result of hemoglobin in Example 1-4 of the present invention.

FIG. 5 is a graph showing the analysis result of hemoglobin in Example 1-5 of the present invention.

FIG. 6 is a graph showing the analysis result of hemoglobin in Example 1-6 of the present invention.

FIG. 7 is a graph showing the analysis result of hemoglobin in Comparative Example 1-1.

FIG. 8 is a graph showing the analysis result of hemoglobin in Comparative Example 1-2.

FIG. 9 is a graph showing the analysis result of hemoglobin in Comparative Example 1-3.

FIG. 10 is a graph showing the analysis result of hemoglobin in Example 2 of the present invention.

FIG. 11 is a graph showing the analysis result of hemoglobin in Comparative Example 2.

FIG. 12 is a graph showing the analysis result of hemoglobin in Example 3 of the present invention.

FIG. 13 is a graph showing the analysis result of hemoglobin in Comparative Example 3.

### DETAILED DESCRIPTION

In the analysis methods of the present invention, the chaotropic anion that is used in the capillary electrophoresis buffer solution and/or the hemoglobin-containing sample is not particularly limited. The capillary electrophoresis buffer solution and/or the hemoglobin-containing sample may comprise at least one of perchlorate ions, thiocyanate ions, iodide ions, bromide ions, trichloroacetic acid ions, and trifluoroacetic acid ions, among other chaotropic anions, in certain aspects of the present invention.

In some aspects of the present invention, the capillary electrophoresis buffer solution and/or the hemoglobin-containing sample comprises both a chaotropic anion and an anionic group-containing compound. The anionic group-containing compound may be an anionic group-containing polysaccharide, for example. The anionic group-containing polysaccharide may be a chondroitin sulfate, in certain aspects of the present invention.

In some aspects of the present invention, a sample to be analyzed comprises at least one of glycated hemoglobin (i.e., HbA1c, among others) sickle cell hemoglobin (HbS), hemoglobin C (HbC), hemoglobin M (HbM or membrane-attached hemoglobin), hemoglobin H (HbH), hemoglobin F (HbF or fetal hemoglobin), and modified Hb, among others. A sample analyzed using methods of the present invention may comprise stable HbA1c and/or unstable HbA1c. In certain aspects of the present invention, a sample to be analyzed comprises at least one modified Hb, such as a carbamoylated Hb or an acetylated Hb, among others. In certain aspects of the present invention, stable HbA1c may be separated from other types of hemoglobin and detected. In some aspects of the present invention, hemoglobin types other than HbA1c may be separated and detected.

In certain aspects of the present invention, the capillary electrophoresis buffer solution (CE buffer solution) and/or the hemoglobin-containing sample comprises at least one chaotropic anion at a concentration between about 10 mmol/L and about 50 mmol/L.

In some aspects of the present invention, the CE buffer solution and/or the hemoglobin-containing sample comprises at least one anionic group-containing compound at a concentration between about 0.01% and about 5% by weight (wt %).

In certain aspects of the present invention, the capillary channel may have an inner diameter of between about 10 μm and about 200 μm.

In some aspects of the present invention, the capillary channel may be made of at least one of glass, fused silica, or a polymeric material (i.e., plastic), among others.

In certain aspects of the present invention, the capillary channel may be uncoated or coated with a coating agent comprising a cationic group or an anionic group, and the coating agent may, optionally, further comprise at least one of silicon, titanium, and zirconium. In some aspects of the present invention, the capillary channel may be coated with a coating agent comprising at least one of silicon, titanium, and zirconium. The coating agent may be a silylation agent, for example, in some aspects of the present invention.

The capillary channel used for electrophoresis in methods of the present invention is not particularly limited. In some aspects of the present invention, the capillary channel may be provided as part of a microchip.

As described above, certain methods of the present invention comprise introducing a sample comprising hemoglobin into an electrophoresis buffer solution in a capillary channel, and then applying voltage to both ends of the capillary channel. The hemoglobin is electrophoresed in the presence of at least one chaotropic anion.

The chaotropic anion exists in solution in the capillary channel at the time of electrophoresis. In certain aspects of the present invention, the chaotropic anion may be added to the sample (prior to its introduction into the capillary channel) and/or the chaotropic anion may be added to a buffer solution in the capillary channel. For example, the chaotropic anion may be added directly to the sample just prior to application to the capillary channel or it may be added to a solution that is used to dilute a hemoglobin-containing specimen, in some aspects of the present invention. In certain aspects, a electrophoresis buffer solution containing the chaotropic anion is used to fill the capillary channel prior to application of a hemoglobin-containing sample.

Not to be bound by theory, a chaotropic ion enhances solubility of a hydrophobic molecule in water by disrupting interactions between water molecules and inhibiting a decrease in the entropy of water caused by contact with a hydrophobic molecule. The chaotropic anions that may be employed in certain aspects of the present invention are not particularly limited. Chaotropic anions that may be used in some aspects of the present invention include: perchlorate ions (ClO₄⁻), thiocyanate ions (SCN⁻), trichloroacetic acid ions (CCl₃COO⁻), trifluoroacetic acid ions (CF₃CO⁻), nitrate ions (NO₃⁻) dichloroacetic acid ions (CCl₂COO⁻), and halogenide ions, among others. In some aspects of the present invention the at least one chaotropic anion may be a thiocyanate ion or a perchlorate ion. In certain aspects the at least one chaotropic anion may be a trifluoroacetic acid ion or a trichloroacetic acid ion. Halogenide ions that may be used in certain aspects of the present invention are not particularly limited. In some aspects of the present invention, capillary electrophoresis of a sample may be carried out in the presence of at least one of fluoride ions (F⁻), chloride ions (Cl⁻), bromide ions (Br⁻), iodide ions (I⁻), and astatide ions (At⁻), among others. In certain aspects of the present invention, the halogenide ions are bromide ions (Br⁻) and/or iodide ions (I⁻). Some aspects of the present invention comprise electrophoresing a sample in the presence of one chaotropic anion, while others comprise electrophoresing a sample in the presence of two or more chaotropic anions.

In certain aspects of the present invention, the chaotropic anion may be added to the sample or the buffer solution or both. The chaotropic anion present during capillary electrophoresis may be introduced as a salt or a compound that generates the chaotropic anion following ionization (i.e., trichloroacetic acid, thiocyanic acid, perchiloric acid, among others). The chaotropic anion may be generated in the sample and/or the buffer solution, when the salt or ion-generating compound is dissolved. The chaotropic anion may be part of an acid salt, a neutral salt, or a basic salt, in some aspects of the present invention. The salts or other compound that generate a chaotropic anion are not particularly limited. In certain aspects of the present invention the chaotropic anion may be introduced as a potassium halide (i.e., such as potassium iodide, or potassium bromide, among others); perchloric acid; thiocyanic acid; trichloroacetic acid; or trifluoroacetic acid; among others. Thus, in some embodiments of the present invention, electrophoresis may be carried out in the presence of a salt containing the chaotropic anion or in the presence of a compound that generates the chaotropic anion by ionization. Addition of a chaotropic anion to the sample and/or the CE buffer solution may be accomplished by adding a salt containing the chaotropic anion or a compound that generates the chaotropic anion by ionization to the sample and/or the CE buffer solution, in some aspects of the present invention.

In certain aspects of the present invention, a concentration of a chaotropic anion in a sample and/or a CE buffer solution at the time of electrophoresis is not particularly limited. In some aspects of the present invention, a sample and/or a CE buffer solution comprises at least one chaotropic anion at a concentration between about 1 mmol/L and about 3000 mmol/L, between about 5 mmol/L and about 100 mmol/L, or between about 10 mmol/L and about 50 mmol/L at the time of electrophoresis.

In some aspects of the present invention, a sample (also referred to as “sample to be analyzed”) to be introduced into the capillary channel is not particularly limited. In certain aspects of the present invention, a sample comprises hemoglobin or is thought to comprise hemoglobin. The hemoglobin-containing sample can comprise blood or products containing hemoglobin that are commercially-available, in some aspects of the present invention. A hemocyte-containing material, such as whole blood, may be hemolyzed to prepare a sample for capillary electrophoresis, in certain aspects of the present invention. The hemolysis method used on a hemocyte-containing material is not particularly limited. In some aspects of the present invention, hemolysis methods include ultrasonic treatments, freeze-thaw treatments, pressure treatments, osmotic pressure treatments, and surfactant treatments, among others known in the art. A hemolysate may be diluted (for example, with a solvent) to prepare the sample for analysis using capillary electrophoresis methods of the present invention. The solvent used for dilution of a hemolysate is not particularly limited. In certain aspects of present invention, a hemolysate may be diluted with water, normal saline solution, or a buffer solution, among others. In some aspects of the present invention, a chaotropic anion may be added at the time of hemolysis and or at the time a hemolysate is diluted. Thus, in certain aspects of the present invention, a solvent used for dilution may comprise at least one chaotropic anion.

In certain aspects of the present invention, the hemoglobin in a sample may be electrophoresed in the presence of both at least one chaotropic anion and at least one anionic group-containing compound. Not to be bound by theory, when an anionic group-containing compound is present during capillary electrophoresis, hemoglobin in a sample may form a complex with the anionic group-containing compound, in some aspects of the present invention. Electrophoresis in the presence of both at least one chaotropic anion and at least one anionic group-containing compound may further improve analysis accuracy and reduce analysis time of hemoglobin-containing samples, in certain aspects of the present invention. The length of the capillary channel may be shortened, if analysis accuracy is increased, in some aspects of the present invention.

The anionic group-containing compound may be added to a sample prior to its application to a capillary channel or it may be added to a buffer solution in the capillary channel to which a sample is applied, in certain aspects of the present invention. In some aspects, the anionic group-containing compound may be added directly to the sample or to a solvent used for diluting a hemoglobin-containing specimen (i.e., hemolysate, among others). In certain aspects, a buffer solution that is used to fill up the capillary channel contains at least one anionic group-containing compound.

The anionic group-containing compound is not particularly limited, and in certain aspects of the present invention, the anionic group-containing compound may be a polysaccharide. In certain aspects of the present invention the anion group-containing compound may be a sulfated polysaccharide, a carboxylic polysaccharide, a sulfonated polysaccharide, or a phosphorylated polysaccharide, among others. A sulfated polysaccharide and/or a carboxylic polysaccharide may be employed in some methods of the present invention. Examples of sulfated polysaccharides that may be used in certain aspects of the present invention include chondroitin sulfate and heparin, among others. In some aspects of the present invention, the anion group-containing compound may be a chondroitin sulfate (i.e., chondroitin sulfate A, chondroitin sulfate B, chondroitin sulfate C, chondroitin sulfate D, chondroitin sulfate E, chondroitin sulfate H, and chondroitin sulfate K, among others). A carboxylic polysaccharide that may be employed in certain aspects of the present invention may be alginic acid or a salt thereof (i.e., sodium alginate). A single anionic group-containing compound may be employed in some aspects of the present invention, while two or more anionic group-containing compounds may be used in other aspects. The concentration of an anionic group-containing compound in the sample, a dilution solvent, and/or the capillary electrophoresis buffer solution is not particularly limited. The concentration of an anionic group-containing compound may be in the sample, solvent, and/or electrophoresis buffer solution at a concentration between about 0.01% and about 5% by weight, or at a concentration between about 0.1% and about 2% by weight.

In certain aspects of the present invention an anionic group-containing compound may be added to the electrophoresis buffer solution that is used during capillary electrophoresis to separate stable HbA1c, unstable HbA1c, and/or modified Hb. Not to be bound by theory, the anionic group-containing compound complexes with each of the stable HbA1c and unstable HbA1c via ionic and/or hydrophobic interactions. The charge states of the stable HbA1c and the unstable HbA1c are different from each other. When each type of HbA1c is complexed with the anionic group-containing compound, the complex is negatively charged as a whole. As discussed above, a chaotropic ion used in methods of the present invention improves water solubility of hydrophobic molecules. Therefore, in the presence of the chaotropic ion, the hydrophobic interactions of the complex are weakened, and the charge state of the stable HbA1c or unstable HbA1c has a great effect on the charge state of the complex. As a result, the difference of the charge state between the stable HbA1c complex and the unstable HbA1c complex is greater than the difference in the charge states of the uncomplexed stable and unstable HbA1c, and it is believed that this larger difference in the charge states that permits their successful separation using capillary electrophoresis. Not to be bound by theory, but the same mechanism may permit the separation of the stable HbA1c from the modified Hb.

The electrophoresis buffer solution used in certain aspects of the present invention is not particularly limited, and may, for example, contain at least one acid. Examples of acids that may be used in the electrophoresis buffer solution include maleic acid, tartaric acid, succinic acid, fumaric acid, phthalic acid, malonic acid, and malic acid, among others. Further, the electrophoresis buffer solution may, for example, contain at least one weak base. Examples of the weak bases that may be used in the electrophoresis buffer solution include arginine, lysine, histidine, and Tris (tris(hydroxymethyl)aminomethane), among others. In some aspects of the present invention the electrophoresis buffer solution may have a pH of between about 4.5 and about 6, between about 4.7 and about 5.2, or about 4.8. The electrophoresis buffer solution may comprise morpholinoethanesulfonic acid (MES),
N-(2-acetamido)iminodiacetic acid (ADA),
N-(2-acetamido)-2-aminoethanesulfonic acid (ACES),
N,N-bis(2-hydroxyethyl)-2-aminoethanesulfonic acid (BES),
3-morpholinopropanesulfonic acid (MOPS),
N-tris(hydroxymethyl)methyl-2-aminoethanesulfonic acid (TES), or
2-[4-(2-hydroxyethyl)-1-piperazinyl]ethanesulfonic acid (HEPES), among others.

The capillary channel used in methods of the present invention is not particularly limited, and the capillary channel may be a capillary tube or it may be a capillary channel formed from the substrate of a microchip in some aspects of the present invention. The capillary channel may be prepared by the person performing the analysis, or a commercially-available device having a capillary channel may be used.

The inner diameter of a capillary channel used in some aspects of the present invention is not particularly limited. In certain aspects of the present invention, the capillary channel used in electrophoresis may have an inner diameter between about 10 μm and about 200 μm, or between about 25 μm and about 100 μm. The length of a capillary channel used in the present invention is not particularly limited. In some aspects of the present invention, the capillary channel may have a length of less than about 15 cm, less than about 10 cm, less than about 5 cm, between about 2 cm and about 3 cm, between about 10 mm and about 1000 mm, or between about 15 mm and about 300 mm. The effective length of a capillary channel used in the present invention is not particularly limited. The effective length of the capillary channel is the distance from the point where the sample begins electrophoresis in the capillary channel to the point along the capillary channel where the Hb may be detected. In certain aspects of the present invention, the capillary channel used in electrophoresis may have an effective length of less than about 15 cm, less than about 10 cm, less than about 5 cm, between about 2 cm and about 3 cm, between about 1 mm and about 1000 mm, or between about 5 mm and about 200 mm.

The capillary channel may be made from materials known in the art. In certain aspects of the present invention a capillary channel may be made from at least one of glass, fused silica, or a polymer (i.e., plastic), and among others. A commercially-available product may be used as the capillary channel. A capillary channel may be made from a glass material, such as synthetic silica glass, or borosilicate glass, among others known in the art. A capillary channel may be made from at least one polymer, such as polymethylmethacrylate (PMMA), polycarbonate (PC), polystyrene (PS), polyethylene (PE), polytetrafluoroethylene (PTFE), polyetheretherketone (PEEK), cycloolefin polymer (COP), polydimethylsiloxane (PDMS), or polylactic acid, among others known in the art.

In some aspects of the present invention, an uncoated capillary channel may be used (e.g., a capillary channel without a coating attached to its inner wall). In certain aspects of the present invention, the inner wall of a capillary channel may be coated with at least one coating agent comprising a cationic group or an anionic group. For example, a compound comprising a cationic group and a reactive group may be used to coat the inner surface of a capillary channel in certain aspects of the present invention. In some aspects of the present invention a capillary channel made of glass or fused silica may be coated with a compound containing a cationic group and at least one of silicon (e.g., a silylation agent), titanium, and zirconium. The cationic group of the coating compound may be an amino group, or an ammonium group, among others. In some aspects of the present invention the coating agent for a capillary channel may be a silylation agent having at least one cationic group (i.e., an amino group or an ammonium group, among others). The cationic group may be a primary amino group, a secondary amino group, or a tertiary amino group, among others, in some aspects of the present invention. Using a silylation agent having a cationic group as the coating agent in a capillary channel may make it possible to further improve analysis accuracy in certain aspects of the present invention.

Examples of silylation agents having a cationic group that may be used as a coating agent include:
N-(2-diaminoethyl)-3-propyltrimethoxysilane, aminophenoxydimethylvinylsilane,
3-aminopropyldiisopropylethoxysilane,
3-aminopropylmethylbis(trimethylsiloxy)silane,
3-aminopropylpentamethyldisiloxane, 3-aminopropylsilanetriol,
bis(p-aminophenoxy)dimethylsilane,
1,3-bis(3-aminopropyl)tetramethyldisiloxane, bis(dimethylamino)dimethylsilane,
bis(dimethylamino)vinylmethylsilane, bis(2-hydroxyethyl)-3-aminopropyltriethoxysilane,
3-cyanopropyl(diisopropyl)dimethylaminosilane,
(aminoethylaminomethyl)phenethyltrimethoxysilane,
N-methylaminopropyltriethoxysilane, tetrakis(diethylamino)silane,
tris(dimethylamino)chlorosilane, and tris(dimethylamino)silane, among others known in the art.

Other coating agents that may be used to coat a capillary channel in some aspects of the present invention include compounds that are analogous to silylation agents having a cationic group where titanium or zirconium atoms are substituted for the silicon atoms. Thus, in some aspects of the present invention, the capillary channel may be coated with a coating agent comprising at least one of silicon, titanium, and zirconium. In some aspects of the present invention, a single silylation agent having a cationic group may be used, while two or more of such silylation agents may be used in combination in certain aspects.

The inner wall of the capillary channel may be coated using a silylation agent by first preparing a treatment solution by dissolving or dispersing the silylation agent in an organic solvent (i.e., dichloromethane, or toluene, among others known in the art). The concentration of a silylation agent in a treatment solution used in some methods of the present invention is not particularly limited. A treatment solution may be passed through a capillary channel made of glass or fused silica, and heated in certain aspects of the present invention. As a result of heating, the silylation agent becomes covalently-bonded to the inner wall of the capillary channel, and a cationic group is arranged along the inner wall. After the heating step, the inner wall of the capillary channel may optionally be washed with at least one of an organic solvent (i.e., dichloromethane, methanol, or acetone, among others), an acid solution (i.e., phosphoric acid solution, among others), an alkaline solution, and a surfactant solution, among others.

In some aspects of the present invention, a capillary channel may be coated with a coating agent comprising an anionic group. In certain aspects of the present invention a compound (i.e., silylation agent, among others) containing an anionic group and a reactive group (i.e., silicon, among others) may be used to coat a capillary channel. In certain aspects of the present invention, a coating agent may comprise an anionic group such as a sulfate group, a carboxylic acid group, a sulfonate group, or a phosphate group, among others. In some aspects of the present invention, coating a capillary channel with a silylation agent having an anionic group may permit improvement of analysis accuracy. Coating of the inner wall of the capillary channel using a silylation agent having an anionic group may be carried out in a manner as described for coating using a silylation agent having a cationic group.

Examples of the silylation agent having an anionic group that may be used in certain aspects of the present invention include:
2-(4-chlorosulfonylphenyl)ethyltrimethoxysilane, and
2-(4-chlorosulfonylphenyl)ethyltrichlorosilane (CSTS), among others known in the art.

To perform analysis of a sample containing at least one type of hemoglobin, an electrophoresis buffer solution may be passed through a capillary channel under applied pressure (i.e., filling the channel using a pump, among others), in certain aspects of the present invention The electrophoresis buffer solution may be passed through a capillary channel for between about 1 minute and about 60 minutes, and the pressure applied when it is passed through the channel may be between about 0.05 MPa and about 0.1 MPa.

Once a capillary channel is filled with an electrophoresis buffer solution, a hemoglobin-containing sample may be introduced into the buffer solution, and voltage may be applied to both ends of the capillary channel to carry out electrophoresis. The hemoglobin-containing sample may be introduced from the anode side of the capillary channel. Application of voltage generates an electroosmotic flow in the electrophoresis buffer solution in the capillary channel and hemoglobin in the applied sample moves toward the cathode end of the capillary channel. In certain aspects of the present invention where an anionic group-containing compound is present during electrophoresis hemoglobin moves toward the cathode end of the capillary channel as part of a complex comprising the hemoglobin and the anionic group-containing compound. The voltage applied to the capillary channel during electrophoresis is sufficient to permit separation of at least one type of hemoglobin in a sample, and may be between about 1 kV and about 30 kV. In some aspects of the present invention, the capillary electrophoresis may be carried out at a temperature between about 1° C. and about 60° C., between about 5° C. and about 35° C., about 20° C., and about room temperature. In certain aspects of the present invention, the electrophoresed hemoglobin may be detected using methods known in art. In some aspects of the present invention an optical method or a fluorescence method may be used to detect electrophoresed hemoglobin. The optical method used for detection of hemoglobin in the present invention is not particularly limited. In some aspects of the present invention, the detection of hemoglobin may be performed by measuring absorbance at a wavelength of between about 400 nm and about 600 nm, or between about 400 nm and about 450 nm, and in certain aspects at a wavelength of about 415 nm and/or at about 550 nm.

A capillary channel that is part of a microchip used in some aspects of the present invention is not particularly limited. A microchip used in the present invention may have a capillary channel formed by digging a groove on a microchip substrate, or a capillary channel may be buried in a groove on a microchip substrate.

The shape of the cross-section of a capillary channel formed by digging a groove on the substrate is not particularly limited. In some aspects of the present invention the cross-section of a capillary channel may be semicircular, or it may have an angular shape (i.e., square-shaped cross-section, among others). The inner wall of the capillary channel that is part of a microchip may or may not be coated as described above, in some aspects of the present invention.

The microchip substrate that a groove is cut into to form a capillary channel is not particularly limited. In certain aspects of the present invention the microchip substrate may comprise glass, fused silica, or polymer (plastic), among others known in the art. A glass microchip substrate may be synthetic silica glass, or borosilicate glass, among others known in the art. A polymer microchip substrate may be selected from those known in the art. A polymer microchip substrate may be polymethylmethacrylate (PMMA), cycloolefin polymer (COP), polycarbonate (PC) polydimethylsiloxane (PDMS), polystyrene (PS), polylactic acid, polyethylene (PE), polytetrafluoroethylene (PTFE), or polyetheretherketone (PEEK), among others known in the art.

A capillary channel that is buried in a groove on a microchip may be made from the same substrates discussed above. Also, the inner wall of a capillary channel buried in a groove formed on a microchip may be coated in the same manner discussed above.

The maximum inner diameter of a capillary channel in a microchip used in some aspects of the present invention may be between about 10 μm and about 200 μm, or between about 25 μm and about 100 μm. In certain aspects of the present invention the cross-sectional shape of a capillary channel in a micro-chip is not a circle, and the maximum inner diameter is the diameter of a circle whose area corresponds to the cross-sectional area of the region of the capillary channel that has a maximal cross-sectional area. The maximum length of a capillary channel in a microchip used in certain aspects of the present invention may be less than about 15 cm, less than about 10 cm, less than about 5 cm, between about 2 cm and about 3 cm, between about 0.1 cm and about 15 cm, or between about 0.5 cm and about 15 cm. The effective length of a capillary channel in a microchip used in some aspects of the present invention may be less than about 15 cm, less than about 10 cm, less than about 5 cm, between about 2 cm and about 3 cm, between about 0.1 cm and about 15 cm, or between about 0.5 cm and about 15 cm.

In certain embodiments of the present invention a microchip having a capillary channel may have a sample introduction channel that forms a cross shape with the capillary channel. The sample introduction channel and the capillary electrophoresis channel may be filled with a buffer solution to which a chaotropic ion is added in some aspects of the present invention. The hemoglobin-containing sample may be introduced into a reservoir formed at one end of the sample introduction channel, and a voltage of between about 0.5 kV and about 10 kV may be applied to the sample introduction channel. By applying this voltage, the hemoglobin-containing sample may be transferred to the cross part (e.g., where the sample introduction channel intersects with the capillary electrophoresis channel). When a voltage of between about 0.5 kV and about 10 kV is applied to the capillary electrophoresis channel, the hemoglobin in a sample moves toward a collection reservoir at one end of the capillary electrophoresis channel. The difference in the rates of movement of different types of hemoglobin separated during electrophoresis may be determined using a detector. The space required for instrumentation to analyze hemoglobin in a sample may be reduced by employing a microchip.

The types of hemoglobin analyzed using methods of the present invention are not particularly limited. In certain aspects of the present invention a hemoglobin-containing sample may comprise normal hemoglobin (HbA0); glycated hemoglobins (i.e., HbA1a, HbA1b, stable HbA1c, unstable HbA1c, and GHbLys, among others); modified hemoglobins (i.e., carbamoylated Hb, and acetylated Hb, among others); genetic variants of hemoglobin (i.e., HbS, HbC, HbM, and HbH, among others); or fetal hemoglobin (HbF); among others. In some aspects of the present invention, stable HbA1c may be separated and detected, and other types of hemoglobin in the sample may be separated from and analyzed simultaneously with the stable HbA1c.

Certain aspects of the present invention are directed to a hemoglobin analysis kit comprising at least one capillary electrophoresis buffer solution having at least one chaotropic anion, and, optionally, at least one of a hemolysis solution, a solvent for diluting a hemolysate, and a microchip having a capillary electrophoresis channel. In some aspects of the present invention, the kit comprises a capillary electrophoresis buffer solution comprising at least one of a perchlorate ion, a thiocyanate ion, a trichloroacetic acid ion, a trifluoroacetic acid ion, an iodide ion, or a bromide ion, among other chaotropic anions. In certain aspects, the kit comprises a capillary electrophoresis buffer solution comprising at least one of a perchlorate ion or a thiocyanate ion. In some aspects, the capillary electrophoresis buffer solution in a kit may comprise at least one anionic group-containing compound (i.e., chondroitin sulfate). In certain aspects of the present invention, a kit comprises a capillary electrophoresis buffer solution comprising a chaotropic anion at a concentration between about 10 mmol/L and about 50 mmol/L, and, optionally, at least one anionic group-containing compound at a concentration between about 0.01 wt % and about 5 wt %. Some aspects of the present invention are directed to a hemoglobin analysis kit comprising a capillary electrophoresis buffer solution and a hemolysis solution, wherein the hemolysis solution comprises at least one chaotropic anion. Certain aspects of the present invention are directed to a hemoglobin analysis kit comprising a capillary electrophoresis buffer solution, a hemolysis solution, and a hemolysate dilution solvent wherein the hemolysate dilution solvent comprises at least one chaotropic anion.

Without further description, it is believed that one of ordinary skill in the art can, using the preceding description and the following illustrative examples, make and utilize the claimed invention. The following working examples therefore, specifically point out embodiments of the present invention, and are not to be construed as limiting in any way the remainder of the disclosure.

### EXAMPLES

The Examples 1-1 to 1-6 that follow disclose analysis methods in which stable HbA1c and unstable HbA1c are separated and detected. Example 2 discloses an analysis method in which stable HbA1c and carbamoylated Hb are separated and detected, and Example 3 discloses an analysis method in which stable HbA1c and acetylated Hb are separated and detected.

### Example 1-1

A hemoglobin-containing sample was prepared as follows. First, glucose was added to whole human blood at a concentration of 500 mg/100 mL, and incubated at 37° C. for 3 hours. After incubation, the reaction mixture was diluted fifteen fold with purified water to produce a hemoglobin-containing sample. Then, a capillary channel made of fused silica (overall length: 32 cm, effective length: 8.5 cm, and inner diameter: 50 μm) was prepared for electrophoresis. A buffer solution (pH 4.8) was prepared comprising a solution of 50 mmol/L fumaric acid-arginine acid with 0.8 % by weight chondroitin sulfate C. Perchloric acid was added to this buffer solution to a concentration of 30 mmol/L. The buffer solution, to which the perchloric acid was added, was used to pressure fill the capillary channel at a pressure of 0.1 MPa (1000 mbar), and then the sample was injected into the anode side of the capillary channel. A 10 kV voltage was applied to both ends of the capillary channel to carry out electrophoresis, and hemoglobin was detected at an absorbance of 415 nm as it was electrophoresed. The effective length of the capillary channel was the length from the sample injection position at the anode side of the capillary channel to the point at which the absorbance was detected.

### Example 1-2

The analysis was performed as in Example 1-1 except that thiocyanic acid, instead of perchloric acid, was added to the buffer solution to a concentration of 30 mmol/L.

### Example 1-3

The analysis was performed as in Example 1-1 except that potassium iodide, instead of the perchloric acid, was added to the buffer solution to a concentration of 30 mmol/L.

### Example 1-4

The analysis was performed as in Example 1-1 except that potassium bromide, instead of perchloric acid, was added to the buffer solution to a concentration of 30 mmol/L.

### Example 1-5

The analysis was performed as in Example 1-1 except that trichloroacetic acid ion, instead of perchloric acid, was added to the buffer solution to a concentration of 30 mmol/L.

### Example 1-6

The analysis was performed as in Example 1-1 except that trifluoroacetic acid ion, instead of perchloric acid, was added to the buffer solution to a concentration of 30 mmol/L.

### Comparative Example 1-1

The analysis was performed as in Example 1-1 except that perchloric acid was not added to the buffer solution.

### Comparative Example 1-2

The analysis was performed as in Example 1-1 except that guanidine (a cationic chaotropic ion), instead of perchloric acid, was added to the buffer solution to a concentration of 30 mmol/L.

### Comparative Example 1-3

The analysis was performed as in Example 1-1 except that urea (a neutral chaotropic ion), instead of perchloric acid, was added to the buffer solution to a concentration of 30 mmol/L.

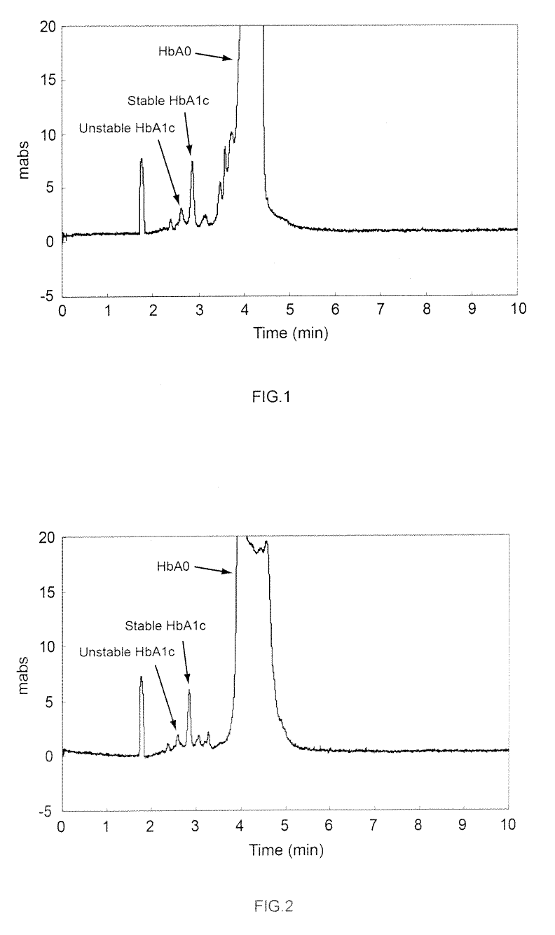

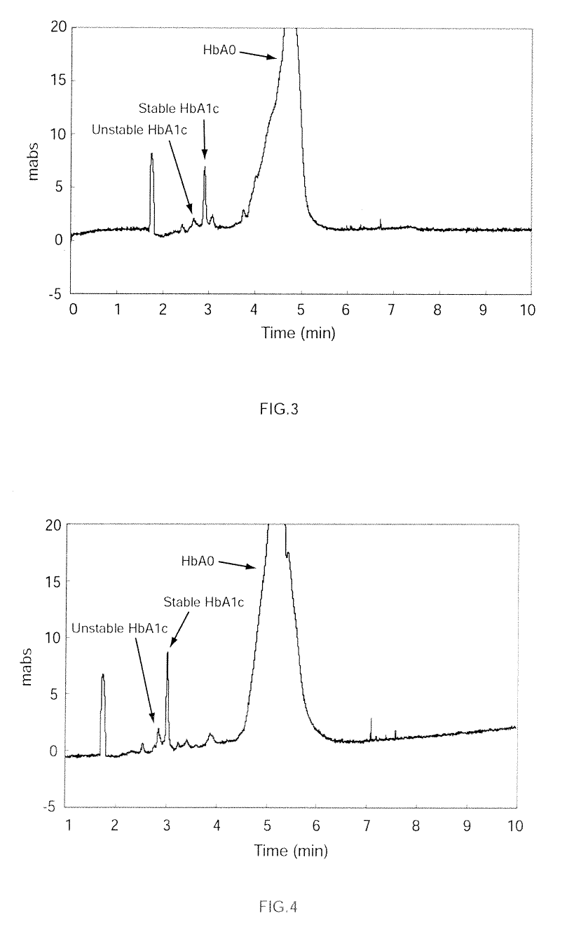

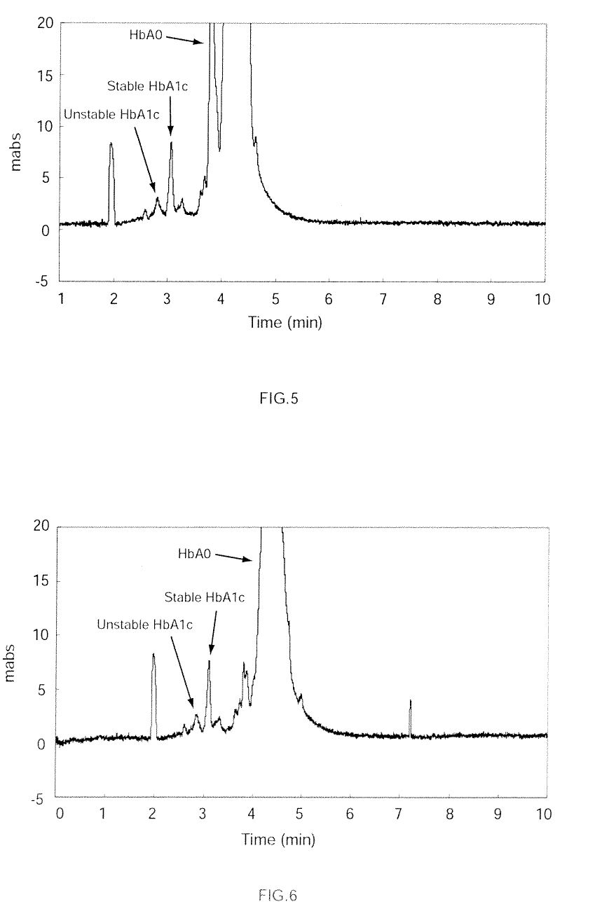

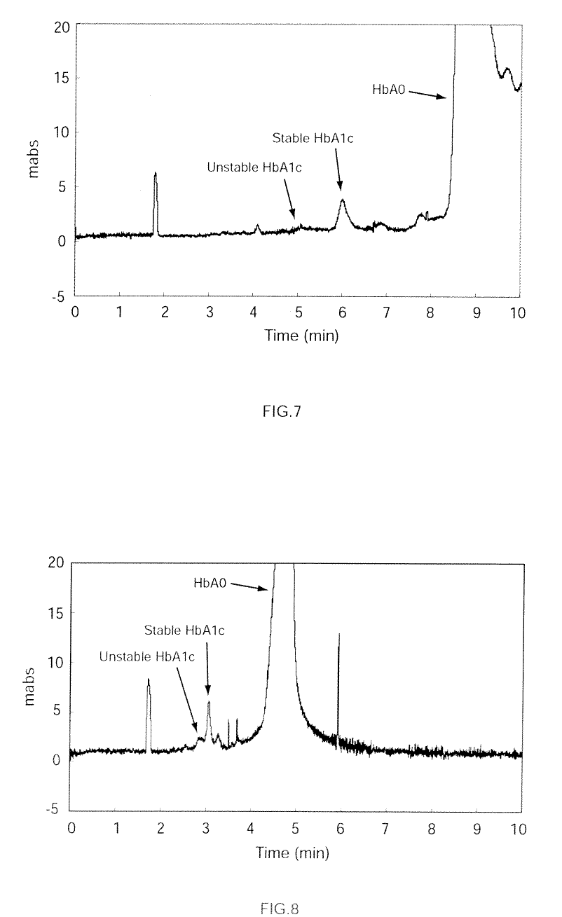

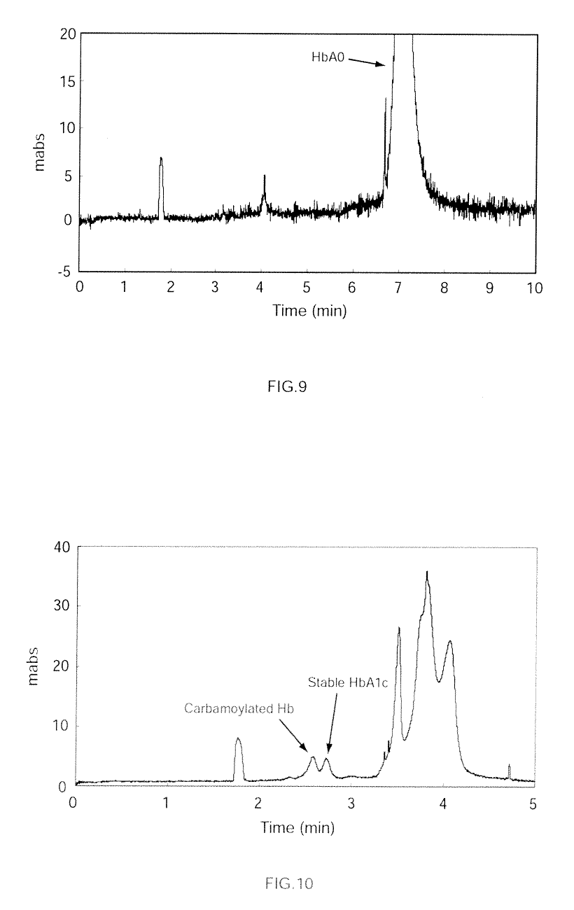

FIG. 1 shows the results of Example 1-1, FIG. 2 shows the results of Example 1-2, FIG. 3 shows the results of Example 1-3, FIG. 4 shows the results of Example 1-4, FIG. 5 shows the results of Example 1-5, and FIG. 6 shows the results of Example 1-6. Further, FIG. 7 shows the results of Comparative Example 1-1, FIG. 8 shows the results of Comparative Example 1-2, and FIG. 9 shows the results of Comparative Example 1-3. In each graph of FIGS. 1 to 9, the vertical (y-) axis corresponds to absorbance measured at 415 nm and the horizontal (x-) axis corresponds to time in minutes. Furthermore, in each graph of FIGS. 1 to 8, the peaks indicated by arrows are, from left to right, unstable HbA1c, stable HbA1c, and HbA0. In FIG. 9, the peak indicated by an arrow is HbA0.

With respect to Examples 1-1 to 1-6 in which a chaotropic anion was added to the buffer solution, each peak for stable HbA1c was detected as separated from the unstable HbA1c and HbA0 peaks. Further, the peaks for stable HbA1c, unstable HbA1c, and HbA0 were all detected within 5 minutes of beginning electrophoresis. In contrast, in Comparative Example 1-1 in which an chaotropic anion was not added to the buffer solution, the peak width of unstable HbA1c was increased, and the peak for unstable HbA1c could not be separated (e.g., resolved) from the peak for stable HbA1c. Further, the peak appeared slowly, and about 10 minutes were required before the HbA0-peak was detected in Comparative Example 1-1. With respect to Comparative Example 1-2 in which guanidine, which is a cationic chaotropic ion, was added to the buffer solution, the peak width for unstable HbA1c was increased, and the peak for unstable HbA1c could not be separated from the peak for stable HbA1c. With respect to Comparative Example 1-3 in which urea, which is a neutral chaotropic ion, was added to the buffer solution, both stable HbA1c and unstable HbA1c peaks could not be separated from the peak for HbA0. As described above, addition of chaotropic anion improves separation of stable HbA1c from unstable HbA1c and HbA0and to significantly reduce the measurement time.

### Example 2

The analysis was performed as in Example 1-1 except that a hemoglobin-containing sample was prepared by adding sodium cyanate at a concentration of 30 mg/100 mL to whole human blood.

### Comparative Example 2

The analysis method was performed as in Example 2 except that the perchloric acid was not added to the buffer solution.

The results of Example 2 are shown in FIG. 10 and the results of Comparative Example 2 are shown in FIG. 11. In each graph of FIGS. 10 and 11, the vertical (y-) axis corresponds to absorbance measured at 415 nm and the horizontal axis corresponds to time in minutes. Further, in each of FIGS. 10 and 11, the peaks indicated by arrows, from left to right, are for carbamoylated Hb and stable HbA1c, respectively.

As shown in FIG. 10, in Example 2, the peak for stable HbA1c was separated from the peak for carbamoylated Hb. Further, in Example 2, the peaks for stable HbA1c and carbamoylated Hb were detected within 3 minutes from the start of electrophoresis and separation and detection could be performed relatively quickly. In contrast, as shown in FIG. 11, in Comparative Example 2, the peak for carbamoylated Hb could not be separated from the peak for stable HbA1c. Further, in Comparative Example 2, 7 minutes were required for the detection of the peak for stable HbA1c. As described above, addition of the chaotropic anion improves separation of stable HbA1c from carbamoylated Hb and to significantly reduce the time required to perform the analysis.

### Example 3

The analysis was performed as in Example 1-1 except that acetaldehyde was added to whole human blood at a concentration of 30 mg 100 mL to prepare a hemoglobin-containing sample, instead of glucose.

### Comparative Example 3

The analysis was performed as in Example 3 except that perchloric acid was not added to the buffer solution.

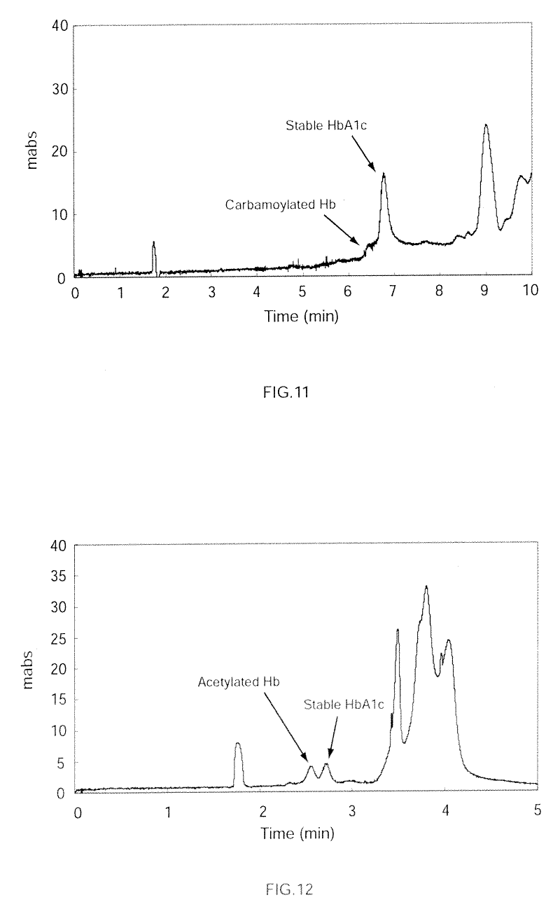

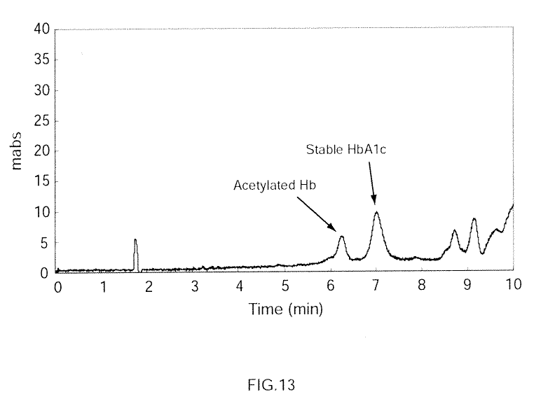

The results of Example 3 are shown in FIG. 12 and the results of Comparative Example 3 are shown in FIG. 13. In each graph of FIGS. 12 and 13, the vertical (y-) axis corresponds to the absorbance measured at 415 nm, and the horizontal (x-) axis corresponds to time in minutes. Further, in each of FIGS. 12 and 13, the peaks indicated by arrows, from left to right, are for acetylated Hb and stable HbA1c, respectively.

As shown in FIGS. 12 and 13, in Example 3 and Comparative Example 3, each peak for stable HbA1c was separated from peaks for acetylated Hb. Further, as shown in FIG. 12, in Example 3, the two peaks were detected within 3 minutes from the start of electrophoresis. In contrast, as shown in FIG. 13, in Comparative Example 3, the peaks appeared slowly and each peak for acetylated Hb and stable HbA1c was detected more than 6 minutes after electrophoresis was begun. As described above, addition of the chaotropic anion significantly reduces the time required to perform the analysis.

Methods for analyzing hemoglobin of the present invention, yield results with high accuracy, reduce analysis times, and the instrumentation requires less lab space than conventional methods. Certain aspects of the present invention may be used in clinical applications, biochemical studies, and medical research, among others.

What is claimed is:

1. A method of analyzing a sample comprising hemoglobin by capillary electrophoresis comprising,
providing a sample comprising at least one type of hemoglobin,
applying the sample to a capillary channel, wherein the capillary channel contains an electrophoresis buffer solution, and wherein at least one of the sample and the electrophoresis buffer solution comprises at least one chaotropic anion,
applying sufficient voltage to the capillary channel to permit separation of the at least one type of hemoglobin, and detecting the separated hemoglobin.

2. The method of claim 1, wherein the chaotropic anion is a perchlorate ion, a thiocyanate ion, a trichloroacetic acid ion, a trifluoroacetic acid ion, an iodide ion, or a bromide ion.

3. The method of claim 1, wherein the chaotropic anions is a perchlorate ion or a thiocyanate ion.

4. The method of claim 1, wherein at least one of the sample and the electrophoresis buffer solution further comprises at least one anionic group-containing compound.

5. The method of claim 1, wherein at least one of the sample and the electrophoresis buffer solution further comprises at least one anionic group-containing polysaccharide.

6. The method of claim 1, wherein at least one of the sample and the electrophoresis buffer solution further comprises chondroitin sulfate.

7. The method of claim 1, wherein the sample comprises at least one of stable HbA1c, unstable HbA1c, HbS, HbC, HbF, and a modified Hb.

8. The method of claim 1, wherein the sample comprises at least one of stable HbA1c and unstable HbA1c.

9. The method of claim 1, wherein the sample comprises at least one of carbamoylated Hb and acetylated Hb.

10. The method of claim 1, wherein at least one of the sample and the electrophoresis buffer solution comprises the at least one chaotropic anion at a concentration between about 1 mmol/L and about 3000 mmol/L.

11. The method of claim 1, wherein at least one of the sample and the electrophoresis buffer solution comprises the at least one chaotropic anion at a concentration between about 5 mmol/L and about 100 mmol/L.

12. The method of claim 1, wherein at least one of the sample and the electrophoresis buffer solution comprises the at least one chaotropic anion at a concentration between about 10 mmol/L and about 50 mmol/L.

13. The method of claim 1, wherein at least one of the sample and the electrophoresis buffer solution further comprises at least one anionic group-containing compound at a concentration between about 0.01 wt % and about 5 wt %.

14. The method of claim 1, wherein at least one of the sample and the electrophoresis buffer solution further comprises at least one anionic group-containing compound at a concentration between about 0.01 wt % and about 2 wt %.

15. The method of claim 1, wherein an inner diameter of the capillary channel is between about 10 μm and about 200 μm.

16. The method of claim 1, wherein an inner diameter of the capillary channel is between about 25 μm and about 100 μm.

17. The method of claim 1, wherein the capillary channel is prepared from at least one of glass, fused silica, or a polymeric material.

18. The method of claim 1, wherein the capillary channel is coated with a coating agent comprising a cationic group or an anionic group on its inner wall.

19. The method of claim 1, wherein the capillary channel is coated with a silylation agent on its inner wall.

20. The method of claim 1, wherein the capillary channel is part of a microchip.

21. The method of claim 1, wherein the electrophoresis buffer solution comprises a chondroitin sulfate, and at least one of a perchlorate ion and a thiocyanate ion.

22. A hemoglobin analysis kit comprising at least one capillary electrophoresis buffer solution, wherein the capillary electrophoresis buffer solution comprises at least one chaotropic anion.

23. The kit of claim 22, further comprising a hemolysis solution.

24. The kit of claim 22, further comprising a solvent for diluting a hemolysate.

25. The kit of claim 22, wherein the kit further comprises a microchip having a capillary electrophoresis channel.

26. The kit of claim 22, wherein the chaotropic anion is a perchlorate ion, a thiocyanate ion, a trichloroacetic acid ion, a trifluoroacetic acid ion, an iodide ion, or a bromide ion.

27. The kit of claim 22, wherein the chaotropic anions is a perchlorate ion or a thiocyanate ion.

28. The kit of claim 22, wherein the capillary electrophoresis buffer solution further comprises at least one anionic group-containing compound.

29. The kit of claim 22, wherein the capillary electrophoresis buffer solution further comprises at least one anionic group-containing polysaccharide.

30. The kit of claim 22, wherein the capillary electrophoresis buffer solution further comprises chondroitin sulfate.

31. The kit of claim 22, wherein the chaotropic anion in the capillary electrophoresis buffer solution is at a concentration between about 10 mmol/L and about 50 mmol/L.

32. The kit of claim 22, wherein the capillary electrophoresis buffer solution further comprises at least one anionic group-containing compound at a concentration between about 0.01 wt % and about 5 wt %.

33. A hemoglobin analysis kit comprising a capillary electrophoresis buffer solution and a hemolysis solution, wherein the hemolysis solution comprises at least one chaotropic anion.

34. A hemoglobin analysis kit comprising a capillary electrophoresis buffer solution, a hemolysis solution, and a hemolysate dilution solvent wherein the hemolysate dilution solvent comprises at least one chaotropic anion.

35. A method of analyzing a sample comprising hemoglobin by capillary electrophoresis comprising,
providing a sample comprising at least one type of hemoglobin,
applying the sample to an uncoated capillary channel, wherein the uncoated capillary channel contains an electrophoresis buffer solution, and wherein at least one of the sample and the electrophoresis buffer solution comprises at least one chaotropic anion,
applying sufficient voltage to the uncoated capillary channel to permit separation of the at least one type of hemoglobin, and
detecting the separated hemoglobin.

36. A method of analyzing a sample comprising hemoglobin by capillary electrophoresis comprising,
providing a sample comprising at least one type of hemoglobin,
applying the sample to a capillary channel having an inner wall coated with a coating agent comprising at least one of silicon, titanium, and zirconium, wherein the capillary channel contains an electrophoresis buffer solution, and wherein at least one of the sample and the electrophoresis buffer solution comprises at least one chaotropic anion,
applying sufficient voltage to the capillary channel to permit separation of the at least one type of hemoglobin, and
detecting the separated hemoglobin.

37. The method of claim 36, wherein the coating agent is a silylation agent.

38. The method of claim 36, wherein the coating agent comprises titanium.

39. The method of claim 36, wherein the coating agent comprises zirconium.

40. The method of claim 36, wherein the coating agent is
N-(2-diaminoethyl)-3-propyltrimethoxysilane, aminophenoxydimethylvinylsilane,
3-aminopropyldiisopropylethoxysilane,
3-aminopropylmethylbis(trimethylsiloxy)silane,
3-aminopropylpentamethyldisiloxane, 3-aminopropylsilanetriol,
bis(p-aminophenoxy)dimethylsilane,
1,3-bis(3-aminopropyl)tetramethyldisiloxane, bis(dimethylamino)dimethylsilane, bis(dimethylamino)vinylmethylsilane, bis(2-hydroxyethyl)-3-aminopropyltriethoxysilane,
3-cyanopropyl(diisopropyl)dimethylaminosilane,
(aminoethylaminomethyl)phenethyltrimethoxysilane,
N-methylaminopropyltriethoxysilane, tetrakis(diethylamino)silane,
tris(dimethylamino)chlorosilane, or tris(dimethylamino)silane.

41. The method of claim 36, wherein the coating agent is
2-(4-chlorosulfonylphenyl)ethyltrimethoxysilane, or
2-(4-chlorosulfonylphenyl)ethyltrichlorosilane (CSTS).

42. A method of analyzing a sample comprising hemoglobin by capillary electrophoresis comprising,
providing a sample comprising at least one type of hemoglobin,
applying the sample to a capillary channel, wherein the capillary channel has an effective length of less than about 15 cm and contains an electrophoresis buffer solution, and wherein at least one of the sample and the electrophoresis buffer comprises at least one chaotropic anion,
applying sufficient voltage to the capillary channel to permit separation of the at least one type of hemoglobin, and
detecting the separated hemoglobin.

43. The method of claim 42, wherein the effective length is less than about 5 cm.

44. The method of claim 42, wherein the effective length is between about 2 cm and about 3 cm.
